(19) United States
(12) Patent Application Publication
(10) Pub. No.: US 2026/0101374 A1
(43) Pub. Date: Apr. 9, 2026

(54) METHODS AND APPARATUSES FOR LCP ENHANCEMENT WITH SHARED COT INFORMATION

(71) Applicant: LENOVO (BEIJING) LIMITED, Beijing (CN)

(72) Inventors: Jing Han, Beijing (CN); Haiming Wang, Beijing (CN); Lianhai Wu, Beijing (CN); Ran Yue, Beijing (CN); Min Xu, Beijing (CN)

(21) Appl. No.: 19/112,707

(22) PCT Filed: Sep. 28, 2022
(86) PCT No.: PCT/CN2022/122048

§ 371 Date: Mar. 18, 2025

(51) Int. Cl. H04W 74/0816; H04W 72/25

(52) U.S. Cl. CPC H04W 74/0816; H04W 72/25

(57) ABSTRACT

The present application relates to methods and apparatuses for logical channel prioritization (LCP) enhancement with shared channel occupancy time (COT) information. One embodiment of the present disclosure provides a user equipment (UE), which includes: a physical layer; a medium access control (MAC) layer; a transceiver; and a processor coupled with the transceiver, wherein the MAC layer is configured to: determine shared COT information for a sidelink (SL) grant; and select a destination and a logic channel (LCH).

### TECHNICAL FIELD

The present disclosure relates to wireless communication, and particularly relates to methods and apparatuses for logical channel prioritization (LCP) enhancement with shared channel occupancy time (COT) information.

### BACKGROUND OF THE INVENTION

In an NR-U scenario, before any transmission, a BS or a UE needs to perform an LBT procedure, and in the case that the LBT procedure is successful, the BS or the UE may perform the transmission, otherwise, the transmission cannot be performed. There are different types of LBT procedures, such as an LBT type 1 procedure or LBT type 2 procedure. The BS or the UE may acquire a channel occupancy (CO) with the LBT type 1 procedure, and the acquired CO may be shared. For example, the BS acquires a CO, and it may share the CO with the UE, and vice versa. The CO may be associated with a time duration, that is, the CO is acquired by the BS for a time duration; the CO may be associated with a frequency band, i.e., the CO is acquired by the BS for the frequency band, or the CO may be associated with both a time duration and a frequency band. Hereinafter in the present disclosure, the term “channel occupancy time (COT)” is used to describe the present disclosure, and persons skilled in the art are aware that the term “COT” and “CO” may also be used interchangeably.

In the COT, instead of the LBT type 1 procedure, the BS or the UE may perform the LBT type 2 procedure before data transmission, which has much shorter sensing period and results in higher transmission efficiency.

For SL-U, it is also an advantage for COT sharing. That is, the SL UE may use the LBT type 2 procedure to access the channel for SL transmission, which has much higher transmission efficiency.

Therefore, it is desirable to provide solutions for LCP enhancement considering the shared COT information.

### SUMMARY

One embodiment of the present disclosure provides a user equipment (UE), which includes: a physical layer; a medium access control (MAC) layer; a transceiver; and a processor coupled with the transceiver, wherein the MAC layer is configured to: determine shared COT information for a sidelink (SL) grant; and select a destination and a logic channel (LCH).

In some embodiments, the UE is in resource allocation mode 2, and the MAC layer is configured to: receive, from the physical layer, a first indication indicating usable shared COT information or unusable shared COT information; determine the usable shared COT information is associated with the SL grant in the case that the first indication indicates the usable shared COT information.

In some embodiments, the UE is in resource allocation mode 2, and the MAC layer is configured to: receive, from the physical layer, a second indication indicating the shared COT information; determine whether the shared COT information is usable for an LCH during an SL grant selection procedure; and determine the shared COT information is associated with the SL grant in the case that the shared COT information is usable.

In some embodiments, the UE is in resource allocation mode 2, and the MAC layer is configured to: receive, from the physical layer, a second indication indicating the shared COT information; determine whether the shared COT information is usable for the SL grant after selecting the SL grant and before multiplexing a MAC protocol data unit (PDU) for the SL grant; and perform an LCP procedure in the case that the shared COT information is usable.

In some embodiments, the UE is in resource allocation mode 1 or resource allocation mode 2, and the MAC layer is configured to: receive, from the physical layer, a second indication indicating the shared COT information; determine whether the shared COT information is usable after selecting the SL grant and after multiplexing a MAC PDU for the SL grant; and select a type of a listen before talk (LBT) procedure based on whether the shared COT information is usable.

In some embodiments, the UE is in resource allocation mode 1 or resource allocation mode 2, and the MAC layer is configured to: receive, from the physical layer, a first indication indicating usable shared COT information or unusable shared COT information; select an LBT type 2 procedure in the case that the first indication indicates the usable shared COT information; or select an LBT type 1 procedure in the case that the first indication indicates the unusable shared COT information.

In some embodiments, the UE is in resource allocation mode 1, and the shared COT information is received from a base station (BS).

In some embodiments, the UE is in resource allocation mode 1, and the MAC layer is configured to: receive, from the physical layer, a second indication indicating the shared COT information; determine whether the shared COT information is usable for the SL grant received from a BS before multiplexing a MAC PDU; and perform an LCP procedure based on whether the shared COT information is usable.

In some embodiments, the MAC layer is configured to select the destination and the LCH based on the shared COT information in the case that the shared COT information is usable, wherein the shared COT information is associated with at least one of the following: a destination ID that is allowed in the shared COT; a destination ID that is associated with at least one LCH with a priority level that is allowed in the shared COT; or an LCH with a priority level that is allowed in the shared COT.

In some embodiments, in the case that no destination is selected in a usable shared COT, or in the case that the SL grant is in an unusable shared COT, and the MAC layer is configured to perform at least one of the following: drop the SL grant; consider no data is multiplexed; trigger a resource reselection procedure in the case that there is no further reserved resources for the SL grant and the UE is in resource allocation mode 2; indicate the physical layer to transmit a non-acknowledgement (NACK) to a BS in the case that there is no further reserved resources for the SL grant and the UE is in resource allocation mode 1; or re-associate a hybrid automatic repeat request (HARQ) process ID of another SL grant and perform a retransmission associated with the another SL grant in the case that the retransmission can be performed in the usable shared COT.

In some embodiments, the UE is in resource allocation mode 1, and in the case that no destination is selected in a usable shared COT, or in the case that the SL grant is in an unusable shared COT, the processor is further configured to: transmit a third indication, to a BS, indicating that no destination is selected in the usable shared COT, or that the SL grant is in the unusable shared COT.

In some embodiments, in the case that an LCP procedure is performed without considering the shared COT information, and a MAC PDU has been multiplexed, the MAC layer is configured to: determine the shared COT information for the SL grant according to at least one of the following: a destination ID, a priority level of the MAC PDU, or the shared COT information received from the physical layer.

In some embodiments, the MAC layer is configured to perform one of the following: perform an LBT type 2 procedure in the case that the shared COT information is usable; drop the MAC PDU in the case that the shared COT information is unusable; or perform an LBT type 1 procedure in the case that the MAC PDU is not to be transmitted in the shared COT.

Another embodiment of the present disclosure provides a BS, which includes: a transceiver; and a processor coupled with the transceiver and configured to: receive shared COT information from a first UE; and transmit an SL grant associated with the shared COT information and the shared COT information to a second UE.

In some embodiments, the processor is further configured to: receive an indication from a UE, indicating that no destination is selected in a usable shared COT, or that the SL grant is in an unusable shared COT.

Yet another embodiment of the present disclosure provides a method performed by a UE, which includes: determining shared COT information for an SL grant; and selecting a destination and an LCH.

Still another embodiment of the present disclosure provides a method performed by a BS, which includes: receiving shared COT information from a first UE; and transmitting an SL grant associated with the shared COT information and the shared COT information to a second UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a scenario of COT sharing for Sidelink UE transmission according to some embodiments of the present disclosure.

FIG. 3 illustrates a method performed by a UE for wireless communication according to some embodiments of the present disclosure.

FIG. 4 illustrates a method performed by a BS for wireless communication according to some embodiments of the present disclosure.

FIG. 5 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, an LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

UE under an NR SL-U scenario may be referred to as an SL UE(s). An SL UE which transmits data on sidelink in an unlicensed spectrum may be referred to as a UE for transmitting, a transmitting UE, a transmitting SL UE, a Tx SL UE, a Tx UE, an SL Tx UE, an SL BWP Tx UE, a UE, or the like. An SL UE which receives data on sidelink in an unlicensed spectrum may be referred to as a UE for receiving, a receiving UE, a receiving SL UE, an Rx UE, an Rx SL UE, an SL Rx UE, a UE, or the like.

An SL UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, personal computer (PC), game terminal, extended reality (XR) devices, or the like.

According to some embodiments of the present disclosure, an SL UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, an SL UE(s) may include wearable devices, such as smart watches, fitness bands, optical head-mounted displays, or the like. Moreover, an SL UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. An SL UE(s) may communicate directly with a BS(s) via communication signals.

A BS under an NR SL-U scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME) or an access and mobility management function (AMF), a serving gateway (SGW), a packet data network gateway (PGW), and/or or a user plane function (UPF).

A BS may serve a number of SL UEs within a serving area, for example, a cell or a cell sector via a wireless communication link. A BS may communicate directly with one or more SL UEs via communication signals. For example, a BS may serve SL UEs within a macro cell.

Sidelink communication between a Tx UE and a receiving (Rx) UE under an NR SL-U scenario includes groupcast communication, unicast communication, or broadcast communication.

FIG. 1 illustrates wireless communication system 100 (e.g., an SL-U communication system) in accordance with some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission in an unlicensed spectrum, such as the SL BWP. UE 101-A, UE 101-B, UE 101-C, and UE 101-D may be referred to as an SL UE. It is contemplated that, in accordance with some other embodiments of the present disclosure, an SL-U communication system may include more BSs and more or fewer SL UEs.

In addition, although the SL UEs as shown in FIG. 1 are illustrated in the shape of a cellphone, it is contemplated that an SL communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange SL messages with UE 101-B or UE 101-C through a sidelink using, for example, the NR technology or the LTE technology, through PC5 interface as defined in 3GPP documents. UE 101-A may transmit information or data to another UE(s) within the SL-U communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

The BS 102 as illustrated and shown in FIG. 1 may not be a specific base station, but may be any base station(s) in the SL-U communication system. For example, assuming that the SL-U communication system includes two BSs, UE 101-A being within a coverage area of any one the two BSs may be called a case where UE 101-A is within the coverage of a BS in the SL-U communication system; and only UE 101-A being outside of a coverage area(s) of both BSs may be called a case where UE 101-A is outside of the coverage of a BS in the SL-U communication system.

UEs may operate in different modes. At least the following two sidelink resource allocation modes are defined for sidelink communication: resource allocation mode 1: a BS may schedule a sidelink resource(s) to be used by a UE for sidelink transmission(s); and resource allocation mode 2: a UE may determine a sidelink transmission resource(s) within sidelink resources configured by a BS or network, or pre-configured sidelink resources. In resource allocation mode 2, a BS may not schedule the sidelink resources for a UE. In FIG. 1, UE 101-A and UE 101-B may be in resource allocation mode 1, and UE 101-C and UE 101-D may be in resource allocation mode 2. In some other cases, UE 101-A and UE 101-B may also operate in resource allocation mode 2. Hereinafter in the present disclosure, “mode 1” may refer to resource allocation mode 1, and “mode 2” may refer to resource allocation mode 2.

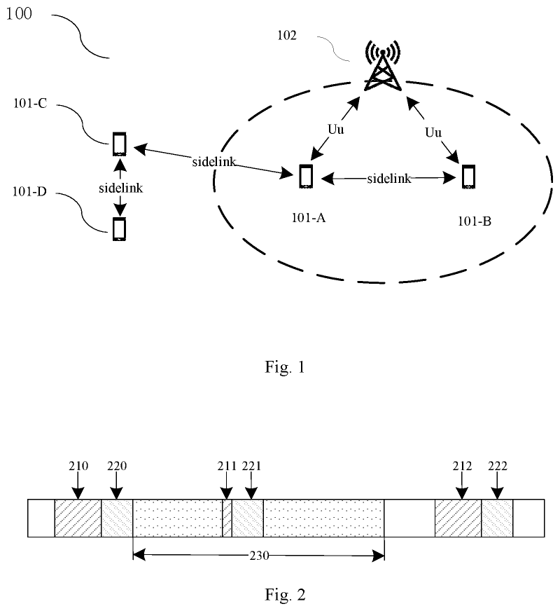

FIG. 2 illustrates a scenario of COT sharing for sidelink UE transmission according to some embodiments of the present disclosure.

In FIG. 2, UE #1 performs a type 1 LBT procedure within the time duration marked by block 210, and within the time duration 220, UE #1 performs data transmission. UE #1 may share COT 230 with UE #2. Within the shared COT 230, UE #2 performs a type 2 LBT procedure within the time duration marked by block 211, and performs data transmission within the time duration 221. When UE #2 needs to perform data transmission out of the shared COT 230, it performs a type 1 LBT procedure within the time duration marked by block 212, and performs data transmission within the time duration 222.

As can be seen, the LBT type 2 procedure is performed for a shorter period compared with the LBT type 1 procedure, thus transmission efficiency is higher.

In conclusion, an SL UE may perform an LBT type 2 procedure to access the channel for transmission in a shared COT, which has much higher transmission efficiency.

During RAN1 #109 meeting discussion, it was agreed that “UE-to-UE COT sharing is supported in NR sidelink operation in a shared channel (SL-U)”, which means an SL UE can acquire the COT and share it with other SL UEs. Further, during RAN1 #110 meeting, the following aspects for COT sharing were agreed upon. Generally speaking, two aspects were agreed upon: 1) only when certain conditions are fulfilled, a responding UE can use the COT shared by initiating UE; and 2) a UE can report COT information to gNB to aid mode 1 resource allocation. After COT sharing information is introduced, an SL UE in both resource allocation mode 1 and resource allocation mode 2 may consider shared COT information when selecting or scheduling a resource(s) for SL transmission. For example, the SL UE or the BS may select or schedule resource inside the shared COT so that LBT type 2 may be used to increase transmission efficiency. On the other hand, if the shared COT information is not considered during the resource allocation procedure, the shared COT information can also be considered during the LCP procedure. In the present disclosure, several solutions for LCP enhancement take the shared COT information into consideration.

An SL UE may determine usable shared COT information for an SL grant, for an LCH, for a MAC PDU, or for a resource for transmission, or for data transmission, etc. Hereinafter in the present disclosure, the term “usable shared COT information” means if a responding UE may utilize the shared COT shared by a COT initiating UE according to specific rules or conditions, the COT may be referred to as an usable shared COT, and the information associated with the shared COT means usable shared COT information. On the other hand, if a responding UE cannot utilize the shared COT shared by a COT initiating UE, the COT may be referred to as an unusable shared COT, and the information associated with the shared COT means unusable shared COT information.

In particular, the MAC layer may determine the usable shared COT information. Hereinafter in the present disclosure, the MAC layer may be a component(s), function(s), means(s), entity(s), instance(s), circuit(s), virtual device(s), logic(s) or the like, that can implement the methods (or steps, operations, or the like) described in the present disclosure. Similarly, the physical layer may also be a component(s), function(s), means(s), entity(s), instance(s), circuit(s), virtual device(s), logic(s) or the like, that can implement the methods (or steps, operations, or the like) described in the present disclosure.

The usable shared COT information may be used for an LCP procedure, if COT sharing is enabled, or if UE received shared COT information is from other SL UEs.

In one embodiment, if COT sharing is enabled for the UE, i.e., an SL UE may receive COT sharing information from another SL UE(s) and can utilize the shared COT when certain conditions are fulfilled, the MAC layer determine whether there is sharing COT information and whether the shared COT can be utilized by an SL UE.

The MAC layer may determine whether there is shared COT information and whether the shared COT can be utilized by an SL UE.

For an SL UE in resource allocation mode 2, i.e., the resource is autonomously selected by the SL UE, and the SL UE may determine whether there is shared COT information and whether the shared COT can be utilized by the SL UE under the following options 1-4:

### Option 1:

The physical layer of the SL UE may determine whether the shared COT information is usable or not, and indicate usable shared COT information along with available resources for resource selection, and the MAC layer may consider the usable shared COT information is associated with the selected SL grant.

Specifically, the physical layer of the SL UE may receive shared COT information from another SL UE(s), and determine whether the shared COT information is usable or not. In the case that the shared COT information is usable, the physical layer may indicate the usable shared COT information along with available resources for resource selection to the MAC layer. The physical layer may determine whether the shared COT can be utilized. For example, the physical layer may determine that the shared COT is overlapped with an SL grant, with a MAC PDU, or with a resource for data transmission, a resource for an LCH, or the like, and the physical layer may determine that the shared COT can be utilized for the SL grant, for the MAC PDU, for the resource, for the data transmission, for the LCH, or the like.

The physical layer may perform the determination during determining the subset of resources for PSSCH resource selection, wherein the MAC layer may indicate the physical layer to perform resource selection.

After the determination, the physical layer may determine the shared COT information, which may be received from another SL UE(s), as usable, or unusable. The physical layer may transmit the information, i.e., the shared COT is usable (usable shared COT information), or the shared COT is unusable (unusable shared COT information), to the MAC layer.

In the case that the shared COT is usable, i.e., the MAC layer receives an indication from the physical layer, indicating usable shared COT information, and the MAC layer may consider the usable shared COT information is associated with the selected SL grant. In other words, the MAC layer may associate the usable shared COT information with the selected SL grant.

### Option 2

In this option, the physical layer may indicate the received shared COT information to the MAC layer, and the MAC layer may determine whether the shared COT information is usable or not during the SL grant selection procedure. In the case that the COT information is usable, the MAC layer may associate the usable shared COT information with the selected SL grant.

Specifically, the physical layer may receive shared COT information from another SL UE(s), and the physical layer may indicate received shared COT information to the MAC layer. In other words, the physical layer may not determine whether the shared COT can be utilized by the SL UE.

After receiving the shared COT information from the physical layer, the MAC layer may determine whether the shared COT can be utilized for the SL UE. The MAC layer may determine whether the shared COT can be utilized, that is, the MAC layer may perform the determination during a resource selection procedure, or an SL grant selection procedure. For example, the MAC layer may determine that the shared COT is overlapped with an SL grant, with a MAC PDU, or with a resource for data transmission, a resource for an LCH, or the like, and the MAC layer may determine that the shared COT can be utilized for the SL grant, for the MAC PDU, for the resource, for the data transmission, for the LCH, or the like.

The MAC layer may consider the usable shared COT information is associated with the selected SL grant. In other words, the MAC layer may associate the usable shared COT information with the selected SL grant.

### Option 3

In this option, the shared COT information is not considered during resource (re) selection phase, the MAC layer may obtain shared COT information from the physical layer, and determine whether the shared COT information is usable or not before MAC PDU multiplexing for the SL grant.

The MAC layer may not determine whether the shared COT information received from the physical layer is usable or unusable during the resource (re) selection procedure or the SL selection procedure. After the resource (re) selection procedure or the SL selection procedure, a specific SL grant may be selected. The MAC layer may determine whether the shared COT information (which is received from the physical layer) is usable or unusable for the specific SL grant before multiplexing the MAC PDU for the SL grant. In some other embodiments, the MAC layer may determine whether the shared COT information is usable or unusable for a specific LCH, for a MAC PDU, etc.

In conclusion, the MAC layer may determine whether the shared COT information is usable or unusable after selecting the SL grant and before multiplexing a MAC PDU for the SL grant.

In the case that the MAC layer determines that the shared COT information is usable, the MAC layer may consider the shared COT information for the LCP procedure, that is, the MAC layer may perform an LCP procedure based on the usable shared COT information.

### Option 4:

In this option, the MAC layer may determine whether the shared COT information received from the physical layer is usable or not after the resource (re) selection procedure or the SL grant selection procedure, and after multiplexing a MAC PDU for the SL grant.

Specifically, the physical layer may receive shared COT information from another SL UE(s), and the physical layer may indicate the received shared COT information to the MAC layer. After the MAC PDU has been multiplexed, i.e., there is a specific MAC PDU, the MAC layer may determine whether the shared COT can be utilized for the specific MAC PDU. In the case that the MAC layer determines that the shared COT information is usable, the MAC layer may consider the information for LBT type selection and data transmission. Specifically, the MAC layer may indicate the physical layer to perform an LBT type 2 procedure in the case that the shared COT information is usable; or indicate the physical layer to perform an LBT type 1 procedure in the case that the shared COT information is unusable. Still, the MAC layer may determine whether the shared COT can be utilized for the SL grant, for a MAC PDU, or for a resource for data transmission, a recourse on an LCH, or the like.

In some other embodiments, the physical layer may determine whether the shared COT can be utilized for the specific MAC PDU, and indicate usable COT information or unusable COT information to the MAC layer. In some other embodiments, the physical layer may determine whether the shared COT can be utilized for the SL grant, for a MAC PDU, or for a resource for data transmission, a recourse on an LCH, or the like.

After the MAC layer receives the indication from the physical layer regarding usable shared COT information, or unusable shared COT information, the MAC layer may perform an LBT type selection.

For an SL UE in resource allocation mode 1, i.e., the SL resource is scheduled and indicated by the BS, the SL UE may determine whether there is shared COT information and whether the shared COT can be utilized by the SL UE under the following options 5-7:

### Option 5:

In resource allocation mode 1, the UE may receive an SL grant(s) as well as associated usable shared COT information from the BS, wherein the MAC layer may store the associated COT information for the SL grant.

### Option 6:

In this option, the UE may receive an SL grant(s) from the BS, and the BS may not indicate the associated usable shared COT information, or the BS may indicate that no COT information is considered. In this case, the UE (i.e., the MAC layer) may consider no usable shared COT information, or no shared COT information for the SL grant from the BS.

The MAC layer may determine whether the shared COT information (which is received from the physical layer) is usable or unusable for the specific SL grant (which is received from the physical layer) before multiplexing the MAC PDU for the SL grant. In some other embodiments, the MAC layer may determine whether the shared COT information is usable or unusable for a specific LCH, for a MAC PDU, etc.

In conclusion, the MAC layer may determine whether the shared COT information is usable or unusable after selecting the SL grant and before multiplexing a MAC PDU for the SL grant.

In the case that the MAC layer determines that the shared COT information is usable, the MAC layer may consider the shared COT information for the LCP procedure, that is, the MAC layer may perform an LCP procedure based on the usable shared COT information.

### Option 7:

In this option, similar to option 6, the UE may receive an SL grant(s) from the BS, and the BS may not indicate the associated usable shared COT information, or the BS may indicate that no COT information is considered. In this case, the UE (i.e., the MAC layer) may consider no usable shared COT information for the SL grant from the BS.

Specifically, the physical layer may receive shared COT information from another SL UE(s), and the physical layer may indicate the received shared COT information to the MAC layer. After the MAC PDU has been multiplexed, i.e., there is a specific MAC PDU, the MAC layer may determine whether the shared COT can be utilized for the specific MAC PDU. In the case that the MAC layer determines that the shared COT information is usable, the MAC layer may consider the information for LBT type selection and data transmission. Specifically, the MAC layer may indicate the physical layer to perform an LBT type 2 procedure in the case that the shared COT information is usable; or indicate the physical layer to perform an LBT type 1 procedure in the case that the shared COT information is unusable. Still, the MAC layer may determine whether the shared COT can be utilized for the SL grant, for a MAC PDU, or for a resource for data transmission, a resource on an LCH, or the like.

In some other embodiments, the physical layer may determine whether the shared COT can be utilized for the specific MAC PDU, and indicate usable COT information or unusable COT information to the MAC layer. In some other embodiments, the physical layer may determine whether the shared COT can be utilized for the SL grant, for a MAC PDU, or for a resource for data transmission, a resource on an LCH, or the like.

After the MAC layer receives the indication from the physical layer regarding usable shared COT information, or unusable shared COT information, the MAC layer may perform an LBT type selection.

In the above options 1-7, for the case an SL grant is associated with a usable shared COT, the MAC layer may determine a destination ID(s) and associated LCHs with priority that is allowed to be transmitted in the usable shared COT, before or during the LCP procedure.

In the above options 1-3, 5, and 6, wherein the MAC PDU has not been multiplexed, in the case that the SL grant is associated with a usable shared COT, the MAC layer may determine (or select) the destination and the LCH taking the usable shared COT information into consideration.

The shared COT information taken into consideration may be associated with at least one of the following restrictions (or conditions):
Restrictions (or conditions) regarding additional destination selection:
i. A destination ID(s) that is allowed to be transmitted in the usable shared COT. For example, some destination IDs are allowed in the usable shared COT, while other destination IDs are not allowed.
ii. A destination ID(s) that is associated with at least one LCH with a priority level that is allowed in the usable shared COT. For example, an LCH with a priority level higher than a predetermined level is allowed in the usable shared COT, while an LCH with a priority level lower than a predetermined level is not allowed in the usable shared COT.
Restriction (or condition) regarding additional LCH selection:
i. The priority level of the LCH is allowed in the usable shared COT. For example, an LCH with a priority level higher than a predetermined level is allowed in the usable shared COT, while an LCH with a priority level lower than a predetermined level is not allowed in the usable shared COT.

For example, if there is associated usable shared COT for a specific SL grant, before the MAC PDU multiplexing or the LCP procedure, the MAC layer may determine that there is a usable shared COT for the SL grant, and the SL UE may perform the LCP procedure for the SL grant based on the usable shared COT information. More specifically, for the destination selection during the LCP procedure, the SL UE may take the above restrictions regarding an additional destination selection into consideration.

The example of the specification is as presented as follows, where the underlined parts are newly introduced according to the solutions of the present disclosure:

| 1> | if sl-BWP-DiscPoolConfig or sl-BWP-DiscPoolConfigCommon is configured | |
|---|---|---|
| | according to TS 38.331 [5]: | |
| | | <text omitted> |
| 1> | else if SL DRX is applied: | |
| | | <text omitted> |
| 1> | else if COT sharing is enabled and if SL grant has associated with a shared COT: | |
| | 2> | select a Destination associated to one of unicast, groupcast and broadcast, that |

| is allowed to be transmitted in shared COT that associated with SL grant, and, | |
|---|---|
| and having at least one of the MAC CE which priority is allowed to be | |
| transmitted in shared COT that associated with SL grant and the logical | |
| channel with the highest priority, among the logical channels that satisfy all | |
| the following conditions and MAC CE(s), if any, for the SL grant associated to | |
| the SCI: | |
| 3> | SL data is available for transmission; and |
| 3> | SBj > 0, in case there is any logical channel having SBj > 0; and |
| 3> | sl-configuredGrantType1Allowed, if configured, is set to true in case the |
| | SL grant is a Configured Grant Type 1; and |
| 3> | sl-AllowedCG-List, if configured, includes the configured grant index |
| | associated to the SL grant; and |
| 3> | sl-HARQ-FeedbackEnabled is set to disabled, if PSFCH is not configured |
| | for the SL grant associated to the SCI. |
| 3> | the LCH priority is allowed to be transmitted in a shared COT that is |

associated with an SL grant

Similarly, for the LCH selection, the SL UE may take the above restrictions regarding an additional LCH selection into consideration. That is, the additional condition needs to be fulfilled for an SL transmission to be transmitted in the usable shared COT, i.e., the LCH priority level associated with the SL transmission is allowed by a usable shared COT.

The example of the specification is as follows, where the underlined parts are newly introduced according to the solutions of the present disclosure:

| 1> | select the logical channels satisfying all the following conditions among the | | |
|---|---|---|---|
| | logical channels belonging to the selected Destination: | | |
| | 2> | SL data is available for transmission; and | |
| | 2> | sl-configuredGrantType1Allowed, if configured, is set to true in case the SL | |
| | | grant is a Configured Grant Type 1; and. | |
| | 2> | sl-AllowedCG-List, if configured, includes the configured grant index | |
| | | associated to the SL grant; and | |
| | 2> | if the LCH priority is allowed in a shared COT that is associated with an SL | |
| | | grant, if COT sharing is enabled and if the SL grant is associated with a shared | |
| | | COT | |
| | 2> | if PSFCH is configured for the sidelink grant associated to the SCI: | |
| | | 3> | sl-HARQ-FeedbackEnabled is set to enabled, if |
| | | | sl-HARQ-FeedbackEnabled is set to enabled for the highest priority |
| | | | logical channel satisfying the above conditions; or |
| | | 3> | sl-HARQ-FeedbackEnabled is set to disabled, if |
| | | | sl-HARQ-FeedbackEnabled is set to disabled for the highest priority |
| | | | logical channel satisfying the above conditions. |
| | 3> | else: | |

| | |
|---|---|
| 4> | sl-HARQ-FeedbackEnabled is set to disabled. |

In some cases, the SL grant may be associated with a usable shared COT, however, no destination can be selected. In some other cases, there may be an available usable shared COT determined before multiplexing the MAC PDU, but the SL grant is in an unusable shared COT. The present disclosure proposes several solutions for solving these technical problems. In particular, the UE (e.g., the MAC layer) may take at least one of the following operations to solve the above technical problems:
drop the SL grant or ignore the SL grant;
consider no data is multiplexed;
trigger a resource reselection procedure in the case that there is no further reserved resources for the SL grant and the UE is in resource allocation mode 2;
indicate the physical layer to transmit a non-acknowledgement (NACK) to a BS in the case that there is no further reserved resources for the SL grant and the UE is in resource allocation mode 1; or
re-associate a hybrid automatic repeat request (HARQ) process ID of another SL grant and perform a retransmission associated with the another SL grant in the case that the retransmission can be performed in the usable shared COT.

In the case that the SL UE is in resource allocation mode 1, the SL UE may also transmit an indication, to a BS, indicating that no destination is selected in the usable shared COT, or indicating that the SL grant is in the unusable shared COT.

For example, when COT sharing is enabled (i.e., there may be a usable shared COT) and an SL grant is associated with a shared COT, however, no destination can be selected during the LCP procedure, i.e., the SL UE cannot find a destination that can be transmitted in associated shared COT for the SL grant; or there is an available usable shared COT determined before multiplexing the MAC PDU, but the SL grant is in an unusable shared COT, the SL UE may drop or ignore the SL grant. Alternatively, the SL UE may consider that no data is multiplexed.

In another example, the SL UE may check whether there is further reserved resource(s) of the SL grant (since the SL grant may reserve more than one resource), if not, i.e., there is no further reserved resources for the SL grant, the SL UE may trigger resource reselection in the case that the SL UE is in resource allocation 2; or indicate the physical layer to transmit a non-acknowledgement (NACK) to the BS in the case that the SL UE is in resource allocation 1.

In another example, the SL UE may check whether the current resource can be used to transmit a MAC PDU of another SL grant that is pending for retransmission. If the SL UE has a pending MAC PDU for retransmission, the SL UE may determine whether the destination and LCH priorities of the pending MAC PDU for retransmission can be transmitted in the usable shared COT based on the above conditions associated with a destination selection and/or LCH selection. In the case that the conditions are fulfilled, the UE may perform the retransmission of the MAC PDU of another SL grant. In some cases, the SL UE may determine that there are multiple MAC PDUs which can be transmitted in the shared COT, and the MAC PDU with the highest priority level may be selected to be transmitted.

In the above options 4 and 7, the MAC layer may determine whether the shared COT information received from the physical layer is usable or not after multiplexing a MAC PDU for the SL grant. The LCP procedure is performed without considering the shared COT information.

That is, after the destination ID and LCH selection procedure, the SL UE may determine whether the MAC PDU to be transmitted is in a shared COT, and whether the shared COT is usable or unusable. Then the SL UE may determine whether the MAC PDU can be transmitted and the LBT type for the MAC PDU transmission under the following operations:
In the case that the MAC PDU is to be transmitted in a usable shared COT, the MAC layer may indicate the physical layer to perform an LBT type 2 procedure, and perform the transmission of the MAC PDU;
In the case that the MAC PDU is to be transmitted in an unusable shared COT, drop the MAC PDU; and/or
In the case that the MAC PDU is to be transmitted not in a shared COT (either usable or unusable), the MAC layer may indicate the physical layer to perform an LBT type 1 procedure, and perform the transmission of the MAC PDU.

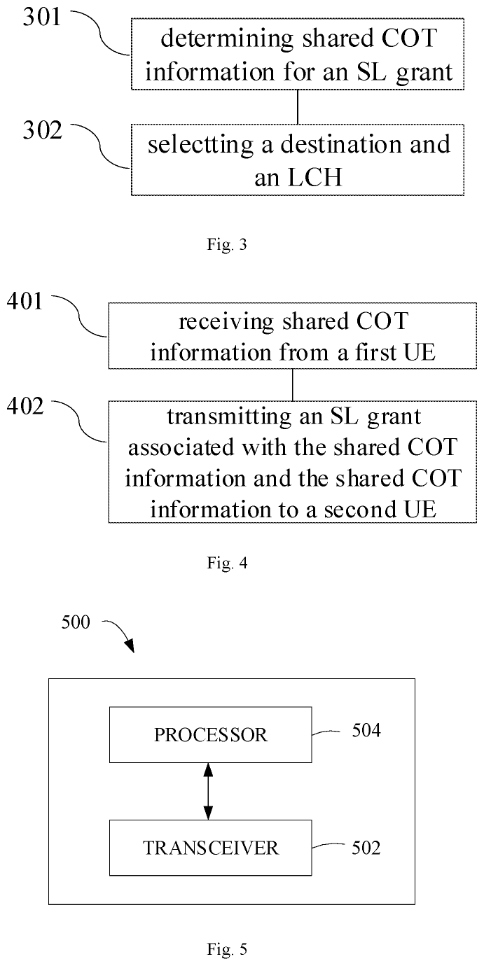

FIG. 3 illustrates a method performed by a UE for wireless communication according to some embodiments of the present disclosure.

In operation 301, the UE may determine shared COT information for an SL grant; and in operation 302, the UE may select a destination and an LCH. In some embodiments, the UE may determine the shared COT information for an LCH, for a MAC PDU, for a resource for data transmission, or the like.

In some embodiments, the UE is in resource allocation mode 2, and the MAC layer is configured to: receive, from the physical layer, a first indication indicating usable shared COT information or unusable shared COT information; and determine the usable shared COT information is associated with the SL grant in the case that the first indication indicates the usable shared COT information.

In some embodiments, the UE is in resource allocation mode 2, and the MAC layer is configured to: receive, from the physical layer, a second indication indicating the shared COT information; determine whether the shared COT information is usable for an LCH during an SL grant selection procedure; and determine the shared COT information is associated with the SL grant in the case that the shared COT information is usable.

In some embodiments, the UE is in resource allocation mode 2, and the MAC layer is configured to: receive, from the physical layer, a second indication indicating the shared COT information; determine whether the shared COT information is usable for the SL grant after selecting the SL grant and before multiplexing a MAC protocol data unit (PDU) for the SL grant; and perform an LCP procedure in the case that the shared COT information is usable.

In some embodiments, the UE is in resource allocation mode 1 or resource allocation mode 2, and the MAC layer is configured to: receive, from the physical layer, a second indication indicating the shared COT information; determine whether the shared COT information is usable after selecting the SL grant and after multiplexing a MAC PDU for the SL grant; and select a type of a listen before talk (LBT) procedure based on whether the shared COT information is usable.

In some embodiments, the UE is in resource allocation mode 1 or resource allocation mode 2, and the MAC layer is configured to: receive, from the physical layer, a first indication indicating usable shared COT information or unusable shared COT information; select an LBT type 2 procedure in the case that the first indication indicates the usable shared COT information; or select an LBT type 1 procedure in the case that the first indication indicates the unusable shared COT information.

In some embodiments, the UE is in resource allocation mode 1, and the shared COT information is received from a base station (BS).

In some embodiments, the UE is in resource allocation mode 1, and the MAC layer is configured to: receive, from the physical layer, a second indication indicating the shared COT information; determine whether the shared COT information is usable for the SL grant received from a BS before multiplexing a MAC PDU; and perform an LCP procedure based on whether the shared COT information is usable.

In some embodiments, the MAC layer is configured to select the destination and the LCH based on the shared COT information in the case that the shared COT information is usable, wherein the shared COT information is associated with at least one of the following: a destination ID that is allowed in the shared COT; a destination ID that is associated with at least one LCH with a priority level that is allowed in the shared COT; or an LCH with a priority level that is allowed in the shared COT.

In some embodiments, in the case that no destination is selected in a usable shared COT, or in the case that the SL grant is in an unusable shared COT, and the MAC layer is configured to perform at least one of the following: drop the SL grant; consider no data is multiplexed; trigger a resource reselection procedure in the case that there is no further reserved resources for the SL grant and the UE is in resource allocation mode 2; indicate the physical layer to transmit a non-acknowledgement (NACK) to a BS in the case that there is no further reserved resources for the SL grant and the UE is in resource allocation mode 1; or re-associate a hybrid automatic repeat request (HARQ) process ID of another SL grant and perform a retransmission associated with the another SL grant in the case that the retransmission can be performed in the usable shared COT.

In some embodiments, the UE is in resource allocation mode 1, and in the case that no destination is selected in a usable shared COT, or in the case that the SL grant is in an unusable shared COT, the processor is further configured to: transmit a third indication, to a BS, indicating that no destination is selected in the usable shared COT, or that the SL grant is in the unusable shared COT.

In some embodiments, in the case that an LCP procedure is performed without considering the shared COT information, and a MAC PDU has been multiplexed, the MAC layer is configured to: determine the shared COT information for the SL grant according to at least one of the following: a destination ID, a priority level of the MAC PDU, or the shared COT information received from the physical layer.

In some embodiments, the MAC layer is configured to perform one of the following: perform an LBT type 2 procedure in the case that the shared COT information is usable; drop the MAC PDU in the case that the shared COT information is unusable; or perform an LBT type 1 procedure in the case that the MAC PDU is not to be transmitted in the shared COT.

Another embodiment of the present disclosure provides a BS, which includes: a transceiver; and a processor coupled with the transceiver and configured to: receive shared COT information from a first UE; and transmit an SL grant associated with the shared COT information and the shared COT information to a second UE.

FIG. 4 illustrates a method performed by a BS for wireless communication according to some embodiments of the present disclosure.

In operation 401, the BS may receive shared COT information from a first UE; and in operation 402, the BS may transmit an SL grant associated with the shared COT information and the shared COT information to a second UE. For example, the first UE may be a COT sharing UE, and the second UE may be a responding UE.

FIG. 5 illustrates a simplified block diagram of an apparatus according to some embodiments of the present disclosure.

As shown in FIG. 5, an example of the apparatus 500 may include at least one processor 504 and at least one transceiver 502 coupled to the processor 504. The apparatus 500 may be a UE, a BS, or any other device with similar functions.

Although in this figure, elements such as the at least one transceiver 502 and processor 504 are described in the singular, the plural is contemplated unless a limitation to the singular is explicitly stated. In some embodiments of the present disclosure, the transceiver 502 may be divided into two devices, such as a receiving circuitry and a transmitting circuitry. In some embodiments of the present disclosure, the apparatus 500 may further include an input device, a memory, and/or other components.

In some embodiments of the present disclosure, the apparatus 500 may be a UE. The transceiver 502 and the processor 504 may interact with each other so as to perform the operations of the UE described in any of FIGS. 1-4. The transceiver 502 and the processor 504 may interact with each other so as to perform the operations of the node described in any of FIGS. 1-4.

In some embodiments of the present disclosure, the apparatus 500 may further include at least one non-transitory computer-readable medium.

For example, in some embodiments of the present disclosure, the non-transitory computer-readable medium may have stored thereon computer-executable instructions to cause the processor 504 to implement the method with respect to the UE as described above. For example, the computer-executable instructions, when executed, cause the processor 504 interacting with transceiver 502 to perform the operations of the UE described in any of FIGS. 1-4.

In some embodiments of the present disclosure, the non-transitory computer-readable medium may have stored thereon computer-executable instructions to cause the processor 504 to implement the method with respect to the devices as described above. For example, the computer-executable instructions, when executed, cause the processor 504 interacting with transceiver 502 to perform the operations of the devices described in any of FIGS. 1-4.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
a physical layer;
a medium access control (MAC) layer;
at least one memory; and
at least one processor coupled with the at least one memory and configured to cause the UE to:
determine shared channel occupancy time (COT) information for a sidelink (SL) grant; and
select a destination and a logic channel (LCH).

2. The UE of claim 1, wherein the UE is in a resource allocation mode 2, and the at least one processor is configured to cause the UE to:
receive a first indication indicating usable shared COT information or unusable shared COT information; and
determine the usable shared COT information is associated with the SL grant in response to the first indication indicating the usable shared COT information.

3. The UE of claim 1, wherein the UE is in a resource allocation mode 2, and the at least one processor is configured to cause the UE to:
receive a second indication indicating the shared COT information;
determine whether the shared COT information is usable for a logic channel (LCH) during a SL grant selection procedure; and
determine the shared COT information is associated with the SL grant in response to the shared COT information being usable.

4. The UE of claim 1, wherein the UE is in a resource allocation mode 2, and the at least one processor is configured to cause the UE to:
receive a second indication indicating the shared COT information;
determine whether the shared COT information is usable for the SL grant after selecting the SL grant and before multiplexing a MAC protocol data unit (PDU) for the SL grant; and
perform a logical channel prioritization (LCP) procedure in response to the shared COT information being usable.

5. The UE of claim 1, wherein the UE is in a resource allocation mode 1 or a resource allocation mode 2, and the at least one processor is configured to cause the UE to:
receive a second indication indicating the shared COT information;
determine whether the shared COT information is usable after selecting the SL grant and after multiplexing a MAC PDU for the SL grant; and
select a type of a listen before talk (LBT) procedure based on whether the shared COT information is usable.

6. The UE of claim 1, wherein the UE is in a resource allocation mode 1 or a resource allocation mode 2, and the at least one processor is configured to cause the UE to:
receive a first indication indicating usable shared COT information or unusable shared COT information;
select a LBT type 2 procedure in response to the first indication indicating the usable shared COT information; or
select a LBT type 1 procedure in response to the first indication indicating the unusable shared COT information.

7. The UE of claim 1, wherein the UE is in a resource allocation mode 1, and the shared COT information is received from a base station.

8. The UE of claim 1, wherein the UE is in a resource allocation mode 1, and the at least one processor is configured to cause the UE to:
receive a second indication indicating the shared COT information;
determine whether the shared COT information is usable for the SL grant received from a BS before multiplexing a MAC PDU; and
perform a LCP procedure based on whether the shared COT information is usable.

9. The UE of claim 1, wherein the MAC layer is configured to select the destination and the LCH based on the shared COT information in response to the shared COT information being usable, wherein the shared COT information is associated with at least one of the following:
a destination ID that is allowed in the shared COT;
a LCH with a priority level that is allowed in the shared COT.

10. The UE of claim 1, wherein, in response to no destination being selected in a usable shared COT, or in response to the SL grant being in a unusable shared COT, and the at least one processor is configured to cause the UE to perform at least one of the following:
drop the SL grant;
consider no data is multiplexed;
trigger a resource reselection procedure in response to there being no further reserved resources for the SL grant and the UE is in a resource allocation mode 2;
indicate the physical layer to transmit a non-acknowledgement (NACK) to a base station in response to there being no further reserved resources for the SL grant and the UE is in a resource allocation mode 1; or
re-associate a hybrid automatic repeat request (HARQ) process ID of another SL grant and perform a retransmission associated with the another SL grant in response to the retransmission being performed in the usable shared COT.

11. The UE of claim 1, wherein the UE is in a resource allocation mode 1, and in response to no destination being selected in a usable shared COT, or in response to the SL grant being in a unusable shared COT, the at least one processor is configured to cause the UE to:
transmit a third indication, to a base station, indicating that no destination is selected in the usable shared COT, or that the SL grant is in the unusable shared COT.

12. The UE of claim 1, wherein, in response to a LCP procedure being performed without considering the shared COT information, and a MAC PDU has been multiplexed, the at least one processor is configured to cause the UE to:
determine the shared COT information for the SL grant according to at least one of the following: a destination ID, a priority level of the MAC PDU, or the shared COT information received from the physical layer.

13. The UE of claim 12, wherein the at least one processor is configured to cause the UE to perform one of the following:
perform a LBT type 2 procedure in response to the shared COT information being usable;
drop the MAC PDU in response to the shared COT information being unusable; or
perform a LBT type 1 procedure in response to the MAC PDU not being transmitted in the shared COT.

14. A base station (BS), comprising:
at least one memory; and
at least one processor coupled with the at least one memory and configured to cause the base station to:
receive shared COT information from a first user equipment (UE); and
transmit a sidelink (SL) grant associated with the shared COT information and the shared COT information to a second UE.

15. A method performed by a user equipment (UE), the method comprising:
determining shared channel occupancy time (COT) information for a sidelink (SL) grant; and
selecting a destination and a logic channel (LCH).

16. A processor for wireless communication, comprising:
at least one controller coupled with at least one memory and configured to cause the processor to:
determine shared channel occupancy time (COT) information for a sidelink (SL) grant; and
select a destination and a logic channel (LCH).

17. The processor of claim 16, wherein the processor is in a resource allocation mode 2, and the at least one controller is configured to cause the processor to:
receive a first indication indicating usable shared COT information or unusable shared COT information; and
determine the usable shared COT information is associated with the SL grant in response to the first indication indicating the usable shared COT information.

18. The processor of claim 16, wherein the processor is in a resource allocation mode 2, and the at least one controller is configured to cause the processor to:
receive a second indication indicating the shared COT information;
determine whether the shared COT information is usable for a logic channel (LCH) during a SL grant selection procedure; and
determine the shared COT information is associated with the SL grant in response to the shared COT information being usable.

19. The processor of claim 16, wherein the processor is in a resource allocation mode 2, and the at least one controller is configured to cause the processor to:
receive a second indication indicating the shared COT information;
determine whether the shared COT information is usable for the SL grant after selecting the SL grant and before multiplexing a medium access control (MAC) protocol data unit (PDU) for the SL grant; and
perform a logical channel prioritization (LCP) procedure in response to the shared COT information being usable.

20. The processor of claim 16, wherein the processor is in a resource allocation mode 1 or a resource allocation mode 2, and the at least one controller is configured to cause the processor to:
receive a second indication indicating the shared COT information;
determine whether the shared COT information is usable after selecting the SL grant and after multiplexing a medium access control (MAC) protocol data unit (PDU) for the SL grant; and
select a type of a listen before talk (LBT) procedure based on whether the shared COT information is usable.
